(19) United States
(12) Patent Application Publication
(10) Pub. No.: US 2015/0116363 A1
(43) Pub. Date: Apr. 30, 2015

(54) User Interface for Mobile Device Including Dynamic Orientation Display

(71) Applicants: Charles Monte, San Rafael, CA (US); Mark Taylor, Paris (FR)

(72) Inventors: Charles Monte, San Rafael, CA (US); Mark Taylor, Paris (FR)

(73) Assignee: SAP AG, Walldorf (DE)

(21) Appl. No.: 14/064,463

(22) Filed: Oct. 28, 2013

(51) Int. Cl. G06T 3/60

(52) U.S. Cl. CPC G06T 3/60
USPC 345/659

(57) ABSTRACT

Embodiments relate to a mobile device user interface (UI), which includes a dynamic orientation display. Based upon inputs to the mobile device, the user interface is configured to orient the display in a particular manner. For example, the nature of the dynamic display may be determined in part, based upon an input (e.g. from level sensors) indicating a physical orientation of the mobile device. Display may further be determined by additional inputs, for example a setting) locking a display changed according to position, or determining a responsiveness/speed of updating the display in response to changed position. The dynamic display according to embodiments can affect a variety of display attributes, including but not limited to the position/shape of individual display elements (e.g. images, text elements), as well as groupings of those display elements (e.g. within a tile). Physical orientation of the device may also determine an identity of information displayed.

### BACKGROUND

Embodiments relate to a user interface, and in particular, to a dynamic orientation display for a mobile device.

Unless otherwise indicated herein, the approaches described in this section are not prior art to the claims in this application and are not admitted to be prior art by inclusion in this section.

Portable electronic devices such as smartphones and tablets, are increasingly relied upon in a wide variety of both personal and professional applications. Such applications may call for one-handed manipulation, with the user's other hand occupied by some other role.

Typical interfaces for a mobile device may allow for a crude selection of display types based upon the physical orientation of the device. One example is the ability to switch display between portrait and landscape display types.

While useful, such conventional approaches ignore more subtle effects arising in conjunction with the physical orientation of a mobile device relative to a user. For example, ergonomic considerations such as a user's handedness (e.g. right-handedness or left-handedness), can influence the nature of the interaction with a mobile device.

The user's handedness can dictate a tilt of the device as held naturally. User handedness can also determine the relaxed/resting location of the user's thumb relative to the screen and elements thereof.

Thus, there is a need for an improved mobile device user interfaces recognizing ergonomic factors. Embodiments address these and other issues by proposing a user interface including a dynamic orientation display for a mobile device.

### SUMMARY

Embodiments relate to a mobile device user interface (UI), which includes a dynamic orientation display. Based upon input(s) to the mobile device, the user interface is configured to orient the display in a particular manner. For example, the nature of the dynamic display may be determined in part, based upon an input (e.g. from gyroscope sensors, level sensors) indicating a physical orientation of the mobile device. Such dynamic display may further be determined by additional types of inputs, for example a setting placing a lock on a display that has been changed according to position, or a setting indicating a responsiveness/speed of changing the display in response to detected change in position. The dynamic display according to embodiments can affect a variety of display attributes, including but not limited to: the position/shape/size of individual display elements (e.g. images, text elements), as well as groupings of those display elements (e.g. within display tiles). Physical orientation of the device may also determine the identity of information that is actually displayed on the screen.

An embodiment of a computer-implemented method comprises causing a display engine of a mobile device to display a plurality of tiles on a screen, and causing a sensor of the mobile device to communicate to the display engine, a first signal indicating a physical orientation of the mobile device. Based upon the first signal, the display engine is caused to show a first display element at a location within one of the plurality of tiles. The sensor is caused to communicate to the display engine, a second signal indicating a changed physical orientation of the mobile device. When the second signal indicates the changed physical orientation passes through a null area, causing the display engine to show the first display element at a different location within the one of the plurality of tiles.

An embodiment of a non-transitory computer readable storage medium embodies a computer program for performing a method comprising causing a display engine of the mobile device to display a plurality of tiles on a screen, and causing a sensor of the mobile device to communicate to the display engine, a first signal indicating a physical orientation of the mobile device. Based upon the first signal, the display engine is caused to show a first display element at a location within one of the plurality of tiles. The sensor is caused to communicate to the display engine, a second signal indicating a changed physical orientation of the mobile device. When the second signal indicates the changed physical orientation passes through a null area, the display engine is caused to show the first display element at a different location within the one of the plurality of tiles.

An embodiment of a computer system comprises one or more processors, and a software program, executable on said computer system. The software program is configured to cause a display engine of a mobile device to display a plurality of tiles on a screen, and to cause a sensor of the mobile device to communicate to the display engine, a first signal indicating a physical orientation of the mobile device. Based upon the first signal, the software program is configured to cause the display engine to show a first display element at a location within one of the plurality of tiles. The software program is configured to cause the sensor to communicate to the display engine, a second signal indicating a changed physical orientation of the mobile device. When the second signal indicates the changed physical orientation passes through a null area, the software program is configured to cause the display engine to show the first display element at a different location within the one of the plurality of tiles.

In certain embodiments the changed spatial location of the mobile device comprises a tilt of the mobile device, and the different location comprises a tilt of the first display element within the tile.

According to some embodiments, the changed spatial location of the mobile device comprises a tilt of the mobile device, and the different location comprises shifting a position of the first display element within the tile.

In various embodiments, based upon the first signal the display engine is also caused to show in the tile, a second display element associated with the first display element, and based upon the second signal, the display engine is caused to also show the second display element at a different location within the tile.

According to particular embodiments the display engine is caused to show the first display element at the different location within the tile based upon the second signal and a direction of the changed physical orientation.

In certain embodiments the display engine is caused to show the first display element at the different location within the tile based upon the second signal and a user personalization setting.

Some embodiments further comprise causing the display engine to show an additional display element based on the second signal.

The following detailed description and accompanying drawings provide a better understanding of the nature and advantages of various embodiments.

### BRIEF DESCRIPTION OF THE DRAWINGS

FIG. 1 shows a simplified view of a mobile device configured with a dynamic display according to an embodiment.

FIG. 1A shows a simplified view of a method of dynamic display according to an embodiment.

FIGS. 2A-C2 illustrate screens of a mobile device configured with dynamic display according to a first example.

FIGS. 3A-C illustrate additional screens of a mobile device configured with dynamic display according to the first example.

FIG. 4 illustrate screens of a mobile device configured with dynamic display according to a second example.

FIG. 5 illustrates hardware of a special purpose computing machine configured to implement dynamic display according to an embodiment.

FIG. 6 illustrates an example of a computer system.

FIG. 7 is a simplified block diagram illustrating a system configured to implement dynamic display according to an embodiment.

FIG. 8 illustrates a simplified flow diagram illustrating a dynamic display process according to an embodiment.

### DETAILED DESCRIPTION

Described herein are techniques for providing a dynamic user interface to a mobile device based upon its orientation. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments relate to a mobile device user interface (UI), which includes a dynamic orientation display. Based upon inputs from the mobile device, the user interface is configured to orient the display in a particular manner. For example, the nature of the dynamic display may be determined in part, based upon an input (e.g. from level sensors) indicating a physical orientation of the mobile device. Such dynamic display may further be determined by additional types of inputs, for example a setting indicating a responsiveness (e.g. rapid/fast or delayed/lazy) in updating the display when a change in device position is detected. The dynamic display according to embodiments can affect a variety of display attributes, including but not limited to the position/shape of individual display components (e.g. images, text elements), as well as groupings of those components (e.g. within display tiles).

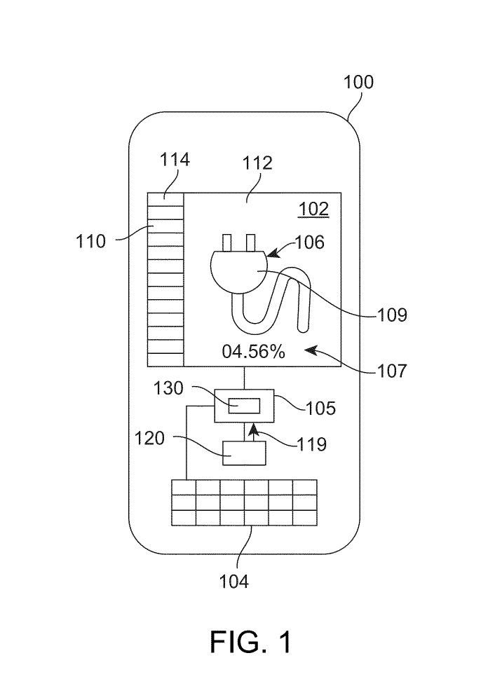

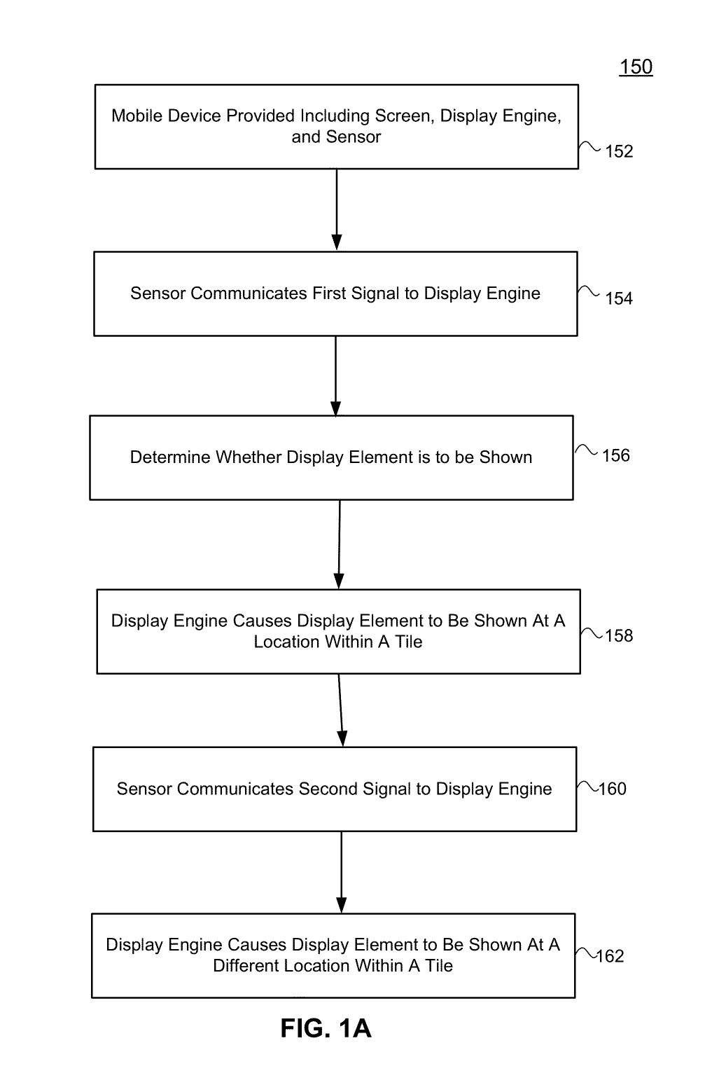

FIG. 1 shows a simplified view of a mobile device according to an embodiment. The mobile device 100 comprises a screen 102. If screen 102 is also touch sensitive, then the screen may also serve as an input device. Otherwise, the mobile device may comprise a separate input device 104 such as a keyboard, track ball, or track pad.

As shown in FIG. 1, based upon instructions from a processor 105, the screen is configured to show various display elements 106. For example, one display element 106 may comprise a text element 107 such as a word or number. Another type of display element may comprise an icon or image 109. Still another display element type 110 may be interactive in nature, for example a slide, dial, or switch.

The various display elements may be shown individually on the screen. Alternatively, multiple screen elements may be organized together as part of a larger group.

Such a grouping of screen components is hereafter also referred to as a “tile”. In the particular embodiment of FIG. 1, the text element 107 and the icon or image 109 are grouped together in a first tile 112. The slide interactive element 110 is located a second tile 114. In various embodiments the slide interactive element may also be included within a single tile with the text and icon or image elements.

According to some embodiments, the screen may be partitioned into a plurality of tiles of the same dimension (e.g. a squares or rectangles). More commonly, however, the screen may be divided up into a plurality of tiles having different dimensions. As described in detail below, in certain embodiments not only a position of the tile, but also a dimension of the tile, may be determined based upon an orientation of the mobile device in space.

In particular, the mobile device further comprises one or more physical sensors 120. One example of such a physical sensor is a gyroscope sensor. Another example of a physical sensor is a level sensor.

The physical sensor(s) can detect a physical orientation of the device in three dimensional space. For example, a physical sensor can not only detect at tilt of the mobile device, but also whether the mobile device is untilted but in an inverted position (i.e. upside down). Another tilt dimension may also be tilted forward or back, thus resulting in a three dimensional orientation attitude.

As described extensively herein, based upon receipt of output signal 119 from sensor(s) 120 indicating the three-dimensional orientation of the mobile device, a display engine 130 of the processor can cause the screen to display the screen components in a particular manner, including the display of the separate tiles. It is noted that separate tile display may have disparate or different display characteristics.

The characteristics of a display may be determined based upon a variety of factors, including but not limited to: the device type (e.g. mobile phone or tablet), the device manufacturer or model, and/or the size of the device screen. As described herein, a physical orientation of the device may also determine the characteristics of a display.

Specific examples of characteristics of the display that can be changed based upon physical orientation of a mobile device, can include but are not limited to:
a location of an individual display element (including within a tile);
a location of a tile;
a size/dimension of an individual display element;
a size/dimension of a tile;
whether or not a display element is shown at all;
whether or not a display element is shown as part of a particular tile.

FIG. 1A shows a simplified view of a method 150 of dynamic display according to an embodiment. In a first step 152 a mobile device is provided comprising a screen and a processor comprising a display engine in communication with a sensor.

In a second step 154 the sensor communicates to the display engine, a first signal indicating a physical orientation of the mobile device. In a third step 156, the display engine determines whether a display element is to be displayed at all based upon the physical orientation. In a fourth step 158, based upon the first signal, if the display element is to be displayed, the display engine causes the display element to be shown at a location within a tile.

In a fifth step 160 the sensor communicates to the display engine, a second signal indicating a changed physical orientation of the mobile device. In a sixth step 162, based upon the second signal the display engine causes the display element to be shown at a different location within the tile.

Particular embodiments of dynamic display according to a physical position of a mobile device, are now described in connection with a couple of examples. The first example relates to an application for an electrical utility worker, in which certain relevant utility information is displayed in a dynamic manner. The second example relates to an application for a construction worker, in which a mobile device is used in an interactive manner for measurement purposes.

### Example 1

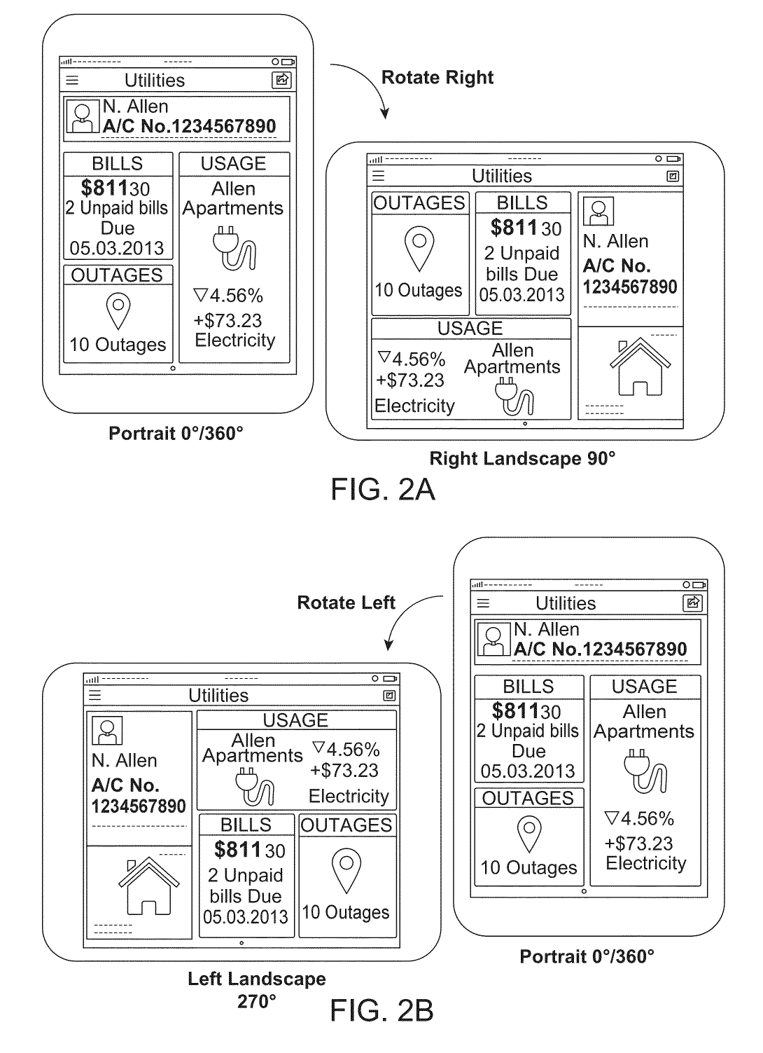

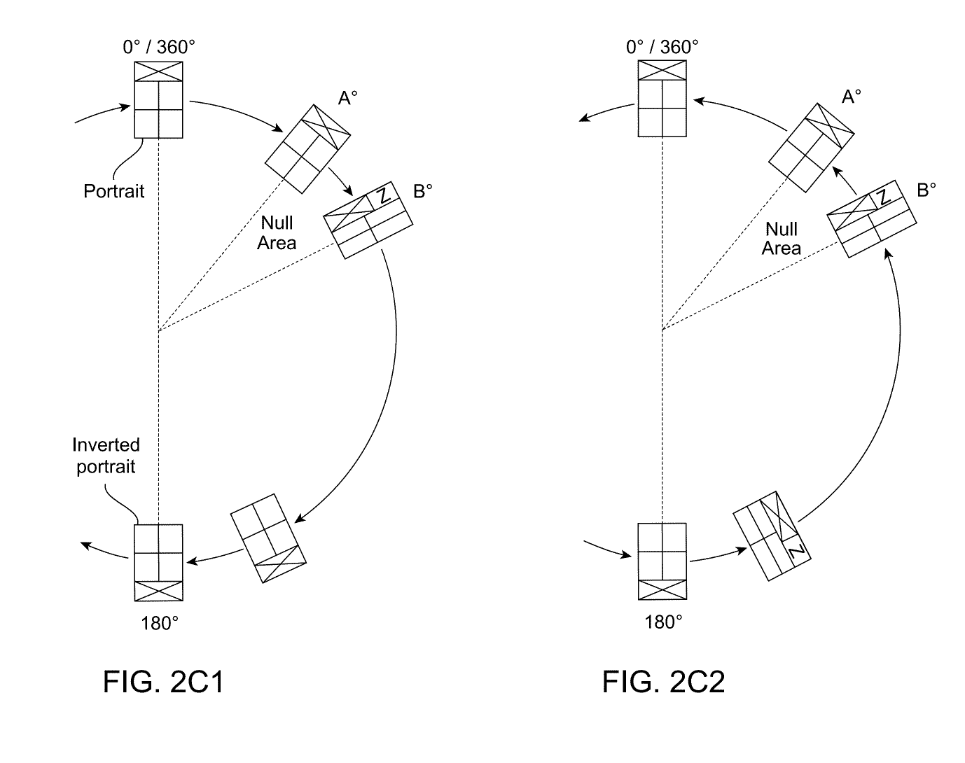

FIGS. 2A-B illustrate screens of a mobile device configured with dynamic display according to a first example. FIG. 2A first shows a display of utility information in a plurality of tiles in portrait format. Upon tilting of the mobile device 90° to the right, the screen display is changed to landscape, and in particular the location of a display element within a tile is changed. Specifically, within the rectangular “Usage” tile, the usage delta now appears to the left of, rather than below, the plug icon.

FIG. 2B again shows a display of utility information in a plurality of tiles in untilted, portrait format. Upon tilting of the mobile device 90° to the left, the screen display is again changed to landscape.

However, the location and arrangement of the tiles (as well as the display elements contained therein) are changed in a different manner than in the case of FIG. 2A. That is, the usage delta now appears to the right of the plug icon within the “Usage” tile.

Moreover, FIG. 2B illustrates that the detected spatial position of the mobile device may not only define the location of information on the screen, but in fact whether certain information is displayed at all. In this particular example, the specific landscape view of FIG. 2B includes an icon of a residence, that is not present in the portrait view of FIG. 2B. Thus, based upon the spatial location information received from the sensor, the display engine has defined not only the location of the display elements, but also the identity of those display elements. As described in detail further below, such omission or inclusion of display elements based upon spatial position, could be determined from user preferences input to the mobile device, and/or from pre-configured preference information of the system (e.g. as implemented in a backend or client application).

While this concept is illustrated in FIG. 2B in connection with an icon, this is not required. In particular embodiments, the display engine could decide whether or not to communicate certain pieces of textual information (e.g. words, numerical values), based upon a detected spatial orientation of the mobile device and/or device type with corresponding available screen size that otherwise would be required to display such information.

A detected change in mobile device spatial location may also result in a different arrangement/location of tiles/display elements in portrait view. That is, holding the device upside down could result in an inversion of display of utility customer information, with that information appearing at the bottom of the screen rather than at the top. This is shown in FIG. 2C, wherein rotation of the mobile device by 180° again results in a portrait orientation, but one in which a tile formerly shown at the top of the screen has been repositioned to the bottom of the screen.

While FIGS. 2A-2B have illustrated a dynamic display in conjunction with changes in spatial location corresponding to tilting in 90° increments, this is not required. Alternative embodiments could recognize and dynamically adjust display of a mobile device based upon changes in spatial location of different magnitudes of granularity. This is also illustrated FIG. 2C1, wherein rotation of the mobile device clockwise 180°, results in a change of display from portrait to landscape after the device passes through a null area between A°-B°, where B° is less than 90°.

According to particular embodiments, a sensed direction of movement of the mobile device (in addition to the changed spatial position), can be considered in determining display. For example, FIG. 2C1 shows that when the device is moved in a clockwise direction, the portrait display is maintained through the null area A°→B°, until the tilt of the device passes B°. (Other null regions that may be present along a full 360° tilt arc are omitted for simplification of illustration.)

By contrast, FIG. 2C2 shows that when the device is moved in a counter-clockwise direction, the landscape display is maintained through the null angular region B°→A°. Thus depending upon the direction of rotation, the display in this null region may either be portrait or landscape.

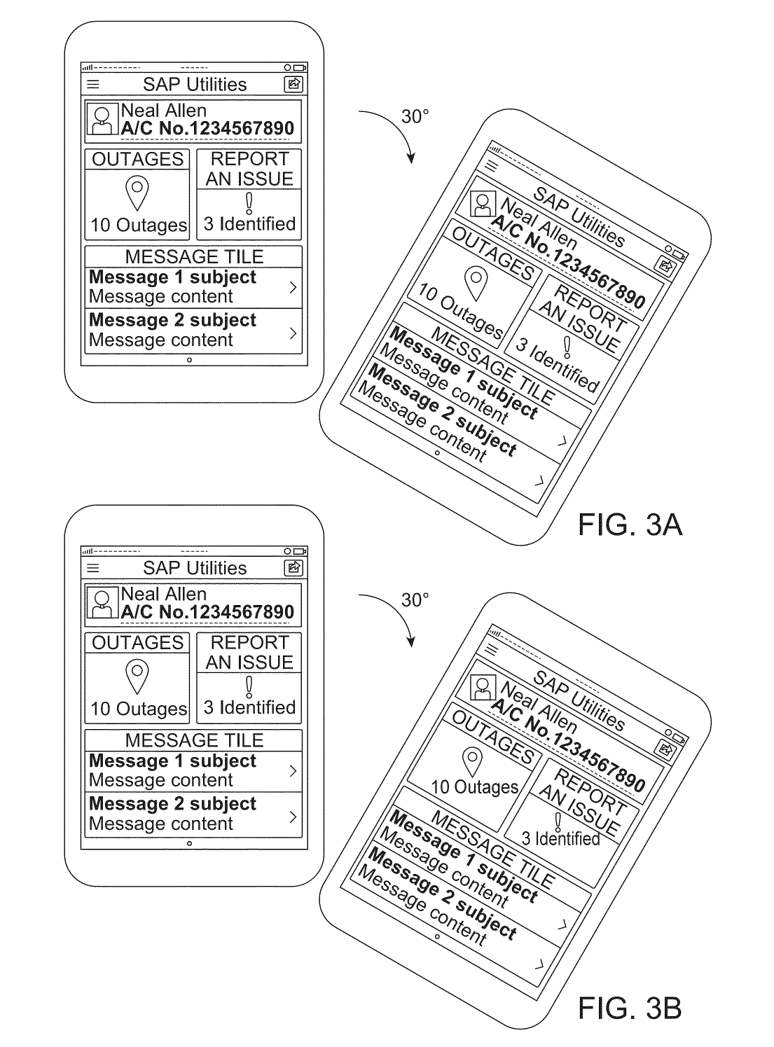

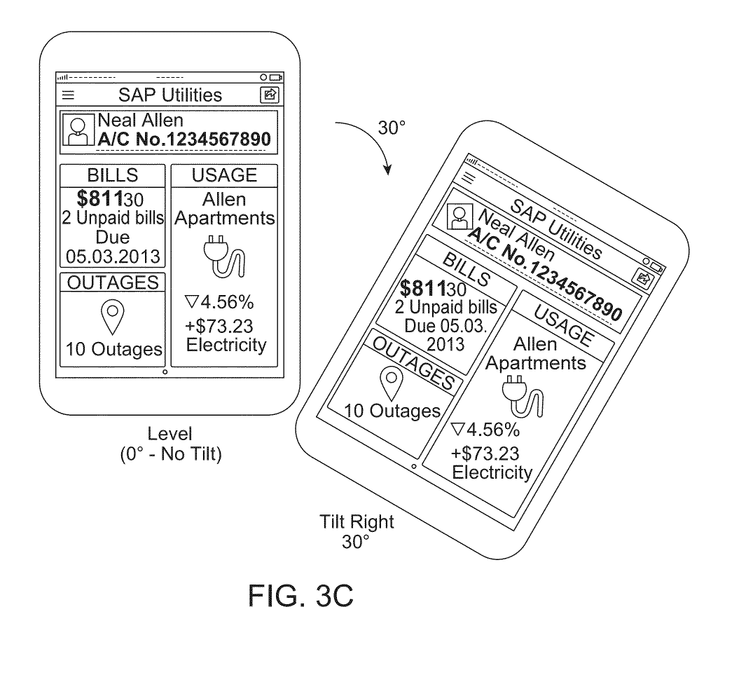

FIGS. 3A-C illustrate additional screens of a mobile device configured with dynamic display according to the first (electrical utility) example. In FIG. 3A, tilting of the mobile device at an angle of 30° to the right, may result in concurrent tilting of icon display elements (only) within their respective tiles. In the embodiment of FIG. 3B, tilting of the mobile device in the same manner may result in concurrent tilting of not only the icon display elements, but also of associated text elements present within the same tile.

Moreover, the nature of the change in the display element resulting from altered spatial position of the mobile device, is not limited to tilting. This is illustrated in the embodiment of FIG. 3C, wherein tilting of the device results not only in tilting of the icon and the associated text, but also shifting of the icon/associated text for relocation within the tile. Here, the usage delta is shifted to the left to occupy space now available in the diagonal of the “Usage” tile.

### Example 2

FIG. 4 illustrate screens of a mobile device configured with dynamic display according to a second example. Here, the mobile device is configured with an interactive display element (a dial). In an untilted position, the dial is positioned within a tile occupying a center of the screen, and a corresponding text display element at a level attitude within the dial. FIG. 4 also shows that upon tilting of the device, however, the location of the text display element may be correspondingly shifted (tilted) within the display tile in order to correct for the angle of tilt.

Such tilting, moreover, may reveal the handedness of right-handed user, by indicating a spatial position in which the mobile device is most naturally held. (The effect of handedness of a user is described in detail below).

Such a right-handed user could have difficulty comfortably accessing the center of the screen with his or her thumb. Accordingly, FIG. 4 also shows the rearrangement of the tiles, to place the interactive (dial) tile on the left half of the screen, thereby easing access to the dial and enhancing user comfort. The applicability of ergonomic concepts to this EXAMPLE 2, is discussed later below.

It is noted that 360° directional screen layouts, defining tile size, content, and placements on the screen in portrait and landscape views, can be logically determined by the left/right and upright/inverted attitude of the smartphone or tablet (via device gyroscope/level sensors). This allows the tile layouts and content to be programmatically re-organized in different tile mosaic patterns according to a user's preference.

In each of the four (4) fundamental 360° device orientations, tiles may be re-scaled to fill the screen, keeping left/right swipe-able pages intact. Additionally, this attribute may eliminate a need to scroll vertically to view tiles that otherwise would be hidden in conventional scaling between portrait and landscape orientations.

When in a 180° portrait orientation, tile placement and content layouts may be inverted according to an “invert portrait” feature. That feature may be deactivated in the settings of the device to afford exact consistency in both 0° and 180° orientations.

As previously mentioned, certain embodiments may employ a tilt effect. Tilt rotation allows certain characters, icons, and data representations to rotate as the device is tilted, thereby keeping tile content (or a portion thereof) level with the user's eye. Users may turn this tilt feature ON/OFF or lock the tilt in a desired position.

Embodiments may thus provide enhanced readability of relevant tile content in any device “Tilt” orientation. Embodiments may also provide affordance in the form of visual cues for discovering device orientations with corresponding layout and content variations.

It is noted that the tilt function is extensible. Tilt may be applied to other UIs and to controls beyond home screen tiles.

Certain embodiments may employ a 30° tilt limit method. Thus, tile elements may rotate up to 30° from level in left and right tilt directions from level (a total of 60° rotation). This can minimize geometric constraints in rotating non-symmetrical shapes within a tile's area.

Some embodiments may feature a directional tilt “null” area. In such embodiments rotating the device from a “level” position beyond the 30° tilt limit, enters into a “null tilt” area whereby the element rotation remains at the 30° tilt, and the orientation corresponding to the level position (landscape or portrait) is unchanged through the null area until a 60° device rotation is achieved. Rotation beyond 60° invokes an orientation change.

And so for example, when starting at a 0° portrait position and rotating clockwise, the portrait orientation will be persistently displayed up to 60°. Then, the orientation is changed to landscape.

Conversely, when starting at a 90° landscape and rotating counter-clockwise through the null area, the landscape orientation is retained until a 30° tilt is achieved, then the orientation is changed to portrait.

In certain embodiments, tilt rotation speed and delay may afford some measure of sensitivity control. Tilt rotation may not be a one-to-one action. A slight delay can be deployed after the start of rotation, in order to create a subtle non-erratic experience.

In concert with such a delay, according to certain embodiments a speed of tilt rotation may vary depending on how fast and how far the user rotates the device. Slight, slow changes in tilt) (5°-15° may incorporate a slow, delayed rotation. Fast/broad changes in tilt) (20°-60° may produce a faster rotation speed to the target angle and orientation in a more rapid “snap” action.

Certain embodiments may provide a lock for tilt and/or orientation. In particular, the user may either “lock” the display tilt angle and orientation according to the attitude the device is being held.

Some embodiments may provide a translucent popover control. Pressing anywhere on the home tile screen, freezes tilt and orientation, grays out background, and displays a translucent popover with two (2) modal tilt lock types selections, a “Lock Now” Button, and a Cancel Button.

Embodiments may variously provide an angle and orientation Indicator. Included in the popover is a simple graphic indicating the locked angle and degrees of tilt.

Tilt sensitivity control may be provided by embodiments. The display engine may deploy an adjustable slight delay after the start of rotation. Variable response when physically rotating the device around a 360° path provides an appropriate tilt response that is automatically tailored for an optimized non-disruptive experience according to the speed, distance and direction of device rotation leading up to the final stationary orientation desired by the user.

Sensitivity control may be located in the settings screen as a slider action that adjusts the amount of tilt delay in combination with the speed of the rotation of screen elements and objects.

Some embodiments may implement a lazy sensitivity. This increases delay and at the same time degreases rotation speed, providing a slower, less responsive tilt action to displayed screen objects and elements. This could be desirable by users who (either by habit or according to function), generally hold the device in a relatively stationary attitude in portrait or landscape orientations.

Responsive sensitivity decreases delay and at the same time increases rotation speed, providing a more responsive, immediate one-to-one correlation between rotating the device and display of tilt actions. This could be desirable by users in demanding ergonomic situations whereby the device is held in rapidly varying attitudes.

The center position may be used as a default setting. It generally provides a highly usable tilt action in most “average” ergonomic usage environments.

Certain embodiments may employ synchronous scaling to tablets and smartphones using a common code-base.

The information architecture and tile layout and size configuration approaches as described herein may be particularly suited to accommodating user handedness, for example. A right-handed anatomical tendency is to use one handed dial operation with the thumb. Using the right hand to both hold the phone and drag/swipe thumb up/down screen to “dial-in” desired value, will naturally orient the phone in a tilt towards the left.

By contrast, left-handed anatomical tendencies are to use one handed dial operation with thumb, with the left hand used to both hold the phone and to drag/swipe the thumb up/down the screen to “dial-in” desired value. This will naturally orient the phone in a tilt towards the right.

As previously mentioned above in connection with the EXAMPLE 2, dynamic orientation according to embodiments may address issues arising from ergonomics and unwanted obscuring of contextual focus, that may be encountered in conventional systems.

Specifically, the application of FIG. 4 calls for manipulation of a vertical dial with the user's thumb. However, using the right hand to hold the phone and adjust the dial may result in naturally obscuring the numeric dial indicia. Conversely, using the left hand to hold the phone and adjust a dial may result in natural obscuring of the numeric dial indicia.

Accordingly, particular embodiments of dynamic orientation display may be configured to automatically detect left- or right-handed use. On the basis of this, embodiments may re-orient tilt of text to be level with user's eye for readability.

Embodiments may maintain optimum one-hand and one finger touch control over a variety of device positions and orientations, by moving the dial indicia away from user's thumb path.

Embodiments may utilize device sensors for detecting “level” phone orientation (tilt) and detecting and determining a user's handed tendencies. Embodiments compensate for device tilt by re-leveling dial numeric values to a user's eye.

One example is in a left dial editing, right handed—level device orientation. Specifically, upon touch the dial is highlighted and value select window is displayed above dial (not obscured by finger). After three (3) seconds, if the user makes no dial adjustments, the highlighted state reverts back to default (non-edit mode) and the set value is automatically saved.

Dial Numeric Indicia may be displayed toward the left-side of dial, so the right thumb cannot obscure characters. Numeric character placement provides screen real estate for right thumb to manipulate dial (drag/swipe/tap) without obscuring dial characters.

By contrast, in a left dial editing, left handed level device orientation, upon touch the dial may be highlighted and value select window is displayed above the dial (not obscured by finger). After three (3) seconds, if the user makes no dial adjustments the highlighted state reverts back to default (non-edit mode) and the set value is automatically saved.

Dial numeric indicia is displayed towards the right-side of the dial, so the left thumb cannot obscure characters. Numeric character placement provides screen real estate for the left thumb to manipulate dial (drag/swipe/tap) without obscuring dial characters.

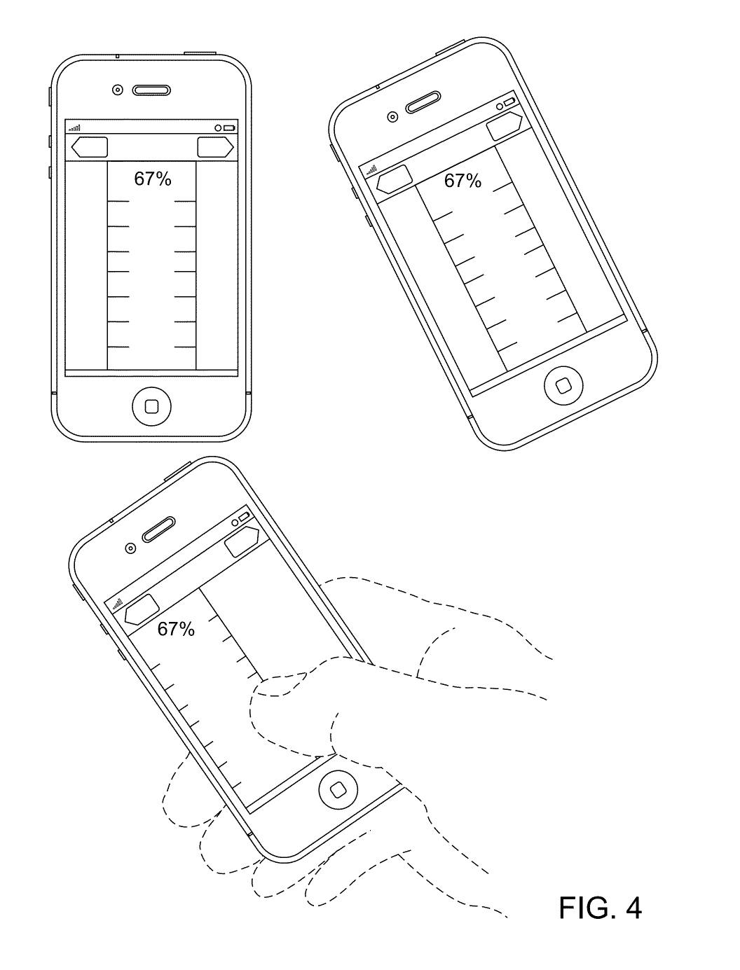

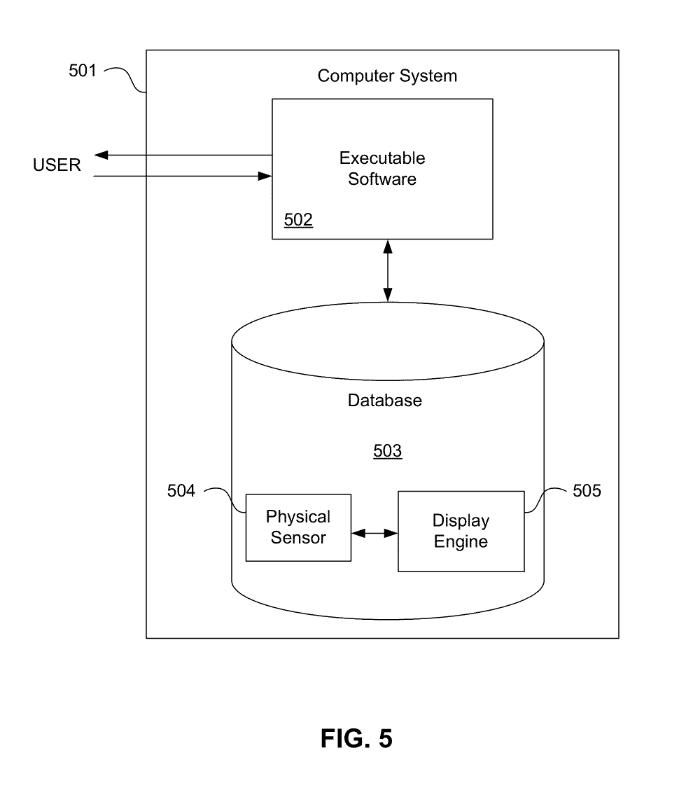

FIG. 5 illustrates hardware of a special purpose computing machine configured to implement a dynamic display according to an embodiment. In particular, computer system 501 comprises a processor 502 that is in electronic communication with a non-transitory computer-readable storage medium 503. This computer-readable storage medium has stored thereon code 504 corresponding to a sensor. Code 505 corresponds to a display engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

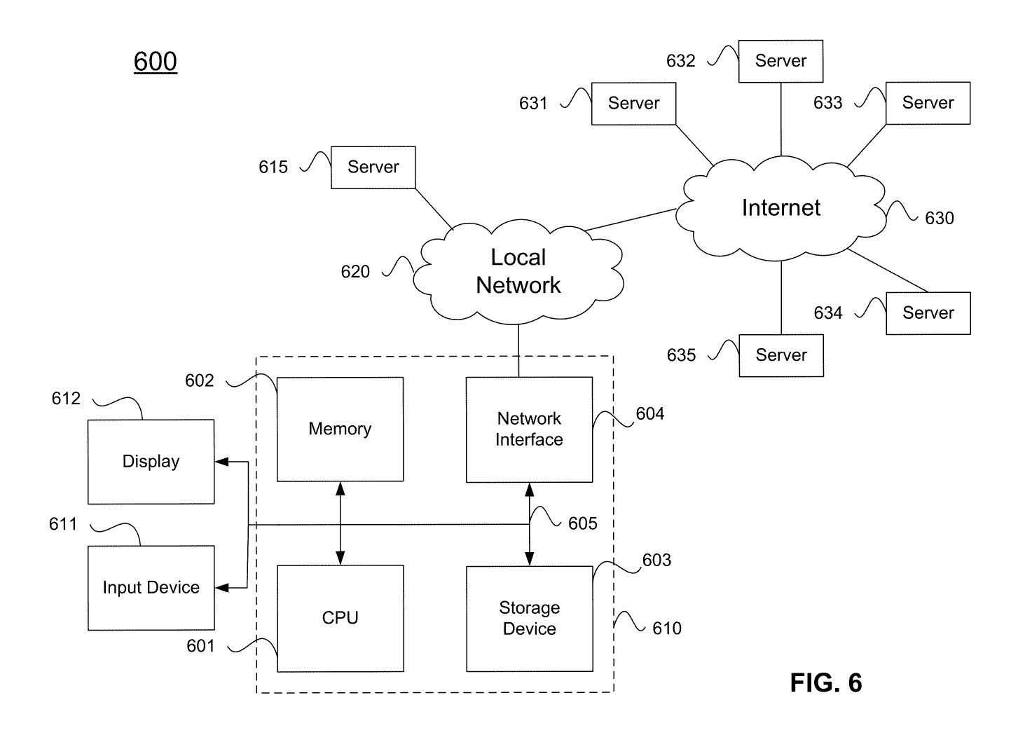

An example system 600 for implementing dynamic display, including a backend, is illustrated in FIG. 6. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable mediums.

Computer system 610 may be coupled via bus 605 to a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

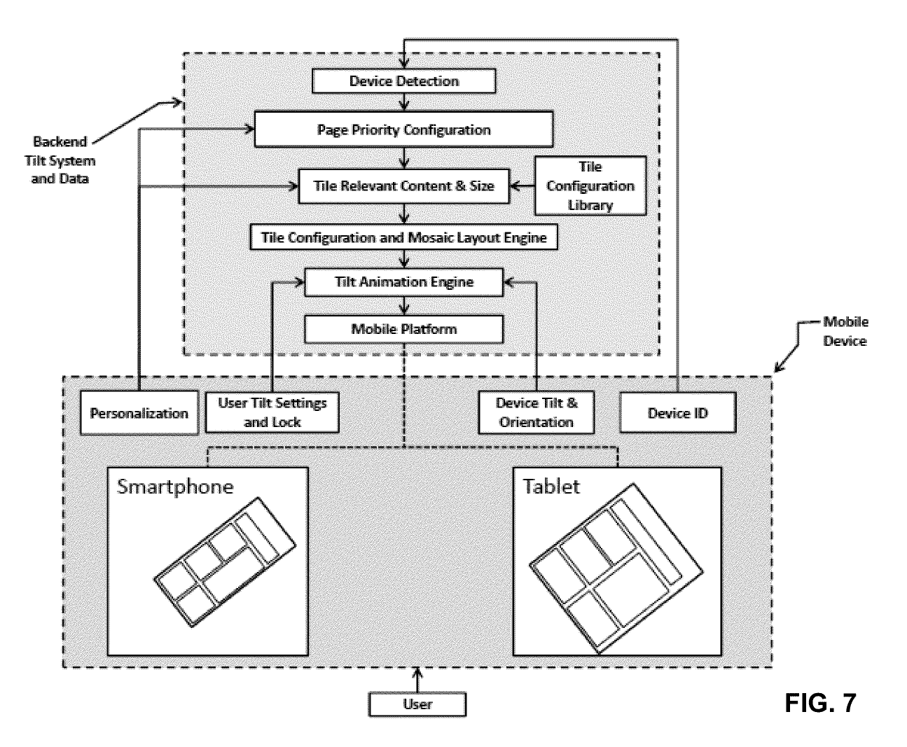

FIG. 7 is a simplified block diagram illustrating one possible embodiment of a system configured to implement dynamic display. This particular architecture employs a backend including a display engine (e.g. tilt animation engine and tile layout engine), that is compatible with a number of different mobile device form factors (e.g. Smartphone, Tablet). The capability for user personalization is illustrated.

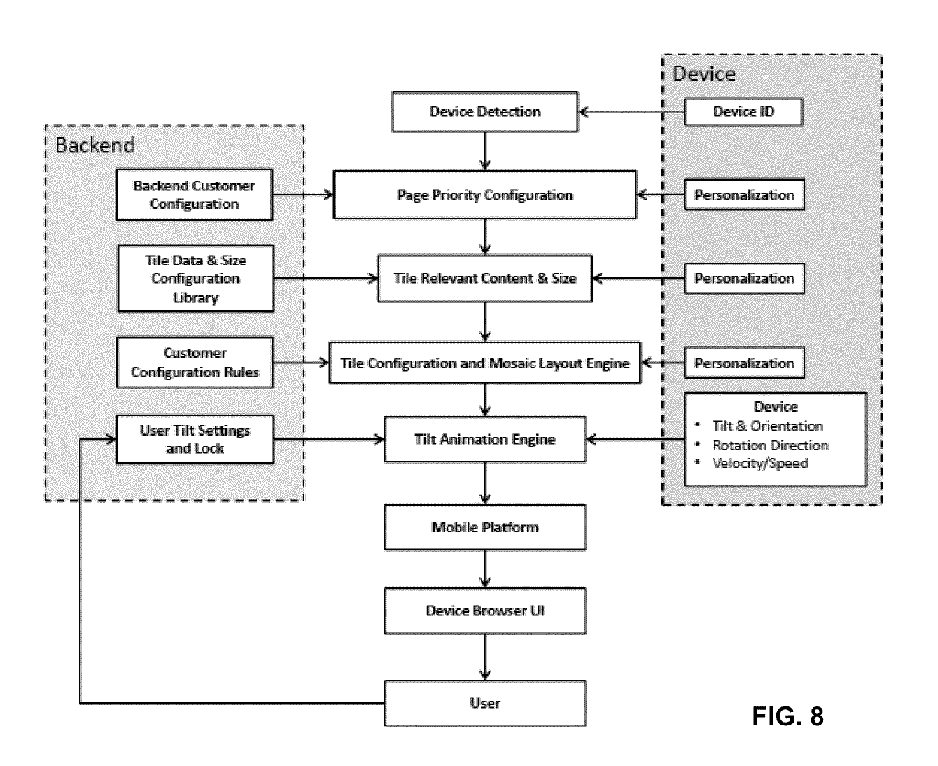

FIG. 8 illustrates a simplified flow diagram illustrating a dynamic display process according to an embodiment. This diagram shows implementation of control over the dynamic display at three different levels:
configuration by the customer on the backend;
configuration of settings and locks by the end user on the backend;
personalization by the end user on the mobile device itself.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing a display engine of a mobile device to display a plurality of tiles on a screen;
causing a sensor of the mobile device to communicate to the display engine, a first signal indicating a physical orientation of the mobile device;
based upon the first signal, causing the display engine to show a first display element at a location within one of the plurality of tiles;
causing the sensor to communicate to the display engine, a second signal indicating a changed physical orientation of the mobile device; and
when the second signal indicates the changed physical orientation passes through a null area, causing the display engine to show the first display element at a different location within the one of the plurality of tiles.

2. The computer-implemented method of claim 1 wherein:
the changed spatial location of the mobile device comprises a tilt of the mobile device; and
the different location comprises a tilt of the first display element within the tile.

3. The computer-implemented method of claim 1 wherein:
the changed spatial location of the mobile device comprises a tilt of the mobile device; and
the different location comprises shifting a position of the first display element within the tile.

4. The computer-implemented method of claim 1 wherein:
based upon the first signal, the display engine is also caused to show in the tile, a second display element associated with the first display element; and
based upon the second signal, the display engine is caused to also show the second display element at a different location within the tile.

5. The computer-implemented method of claim 1 wherein:
the display engine is caused to show the first display element at the different location within the tile based upon the second signal and a direction of the changed physical orientation.

6. The computer-implemented method of claim 1 wherein:
the display engine is caused to show the first display element at the different location within the tile based upon the second signal and a user personalization setting.

7. The computer-implemented method of claim 1 further comprising:
based upon the second signal, causing the display engine to show an additional display element.

8. A non-transitory computer readable storage medium embodying a computer program for performing a method, said method comprising:
causing a display engine of the mobile device to display a plurality of tiles on a screen;
causing a sensor of the mobile device to communicate to the display engine, a first signal indicating a physical orientation of the mobile device;
based upon the first signal, causing the display engine to show a first display element at a location within one of the plurality of tiles;
causing the sensor to communicate to the display engine, a second signal indicating a changed physical orientation of the mobile device; and
when the second signal indicates the changed physical orientation passes through a null area, causing the display engine to show the first display element at a different location within the one of the plurality of tiles.

9. A non-transitory computer readable storage medium as in claim 7 wherein:
the changed spatial location of the mobile device comprises a tilt of the mobile device; and
the different location comprises a tilt of the first display element within the tile.

10. A non-transitory computer readable storage medium as in claim 7 wherein: the changed spatial location of the mobile device comprises a tilt of the mobile device; and
the different location comprises shifting a position of the first display element within the tile.

11. A non-transitory computer readable storage medium as in claim 7 wherein:
based upon the first signal, the display engine is also caused to show in the tile, a second display element associated with the first display element; and
based upon the second signal, the display engine is caused to also show the second display element at a different location within the tile.

12. A non-transitory computer readable storage medium as in claim 7 wherein:
the display engine is caused to show the first display element at a different location within the tile based upon the second signal and a direction of the changed physical orientation.

13. A non-transitory computer readable storage medium as in claim 7 wherein:
the display engine is caused to show the first display element at the different location within the tile based upon the second signal and a user personalization setting.

14. A non-transitory computer readable storage medium as in claim 7 further comprising:
based upon the second signal, causing the display engine to show an additional display element.

15. A computer system comprising:
one or more processors;
a software program, executable on said computer system, the software program configured to:
cause a display engine of a mobile device to display a plurality of tiles on a screen;
cause a sensor of the mobile device to communicate to the display engine, a first signal indicating a physical orientation of the mobile device;
based upon the first signal, cause the display engine to show a first display element at a location within one of the plurality of tiles;
cause the sensor to communicate to the display engine, a second signal indicating a changed physical orientation of the mobile device; and
when the second signal indicates the changed physical orientation passes through a null area, cause the display engine to show the first display element at a different location within the one of the plurality of tiles.

16. A computer system as in claim 15 wherein:
the changed spatial location of the mobile device comprises a tilt of the mobile device; and
the different location comprises a tilt of the first display element within the tile.

17. A computer system as in claim 15 wherein:
the changed spatial location of the mobile device comprises a tilt of the mobile device; and
the different location comprises shifting a position of the first display element within the tile.

18. A computer system as in claim 15 wherein:
based upon the first signal, the display engine is also caused to show in the tile, a second display element associated with the first display element; and
based upon the second signal, the display engine is caused to also show the second display element at a different location within the tile.

19. A computer system as in claim 15 wherein:
the display engine is caused to show the first display element at a different location within the tile based upon the second signal and a direction of the changed physical orientation.

20. A computer system as in claim 15 wherein:
the display engine is caused to show the first display element at the different location within the tile based upon the second signal and a user personalization setting.
